(19) United States
(12) Patent Application Publication
(10) Pub. No.: US 2016/0320940 A1
(43) Pub. Date: Nov. 3, 2016

(54) METHOD AND APPARATUS FOR SETTING POSITION OF MOVING CURSOR IN DISPLAY PAGE WITH LINKS

(71) Applicants: LE HOLDINGS (BEIJING) CO., LTD., Beijing (CN); LE SHI INTERNET INFORMATION TECHNOLOGY CORP. BEIJING, Beijing (CN)

(72) Inventor: Chaohua HE, Beijing (CN)

(21) Appl. No.: 15/107,890

(22) PCT Filed: Nov. 26, 2014
(86) PCT No.: PCT/CN2014/092311

§ 371 Date: Jun. 23, 2016

(30) Foreign Application Priority Data
Dec. 25, 2013 (CN) 201310728651.8

(51) Int. Cl. G06F 3/0481; G06F 3/0482

(52) U.S. Cl. CPC G06F 3/04812; G06F 3/0482

(57) ABSTRACT

A method for setting a position of a moving cursor in a display page with links is characterized by including: obtaining options with links in a display page prior to output display of the display page with the links is carried out; gathering options of the same type among the obtained options to form a set; and setting a focus position of a first residence of a moving cursor when the moving cursor moves to the set, keeping the focus position still relative to an interface where the focus position is located, and enabling all the options in the set to move to the focus position in sequence according to a movement instruction of a user. The problem that in the conventional ways, a control device on an apparatus cannot achieve quick and accurate locating of the moving cursor is solved.

### CROSS-REFERENCE TO RELATED APPLICATIONS

The present disclosure is based upon and claims priority to Chinese Patent Application No. 201310728651.8, filed on Dec. 25, 2013, the entire contents of which are incorporated herein by reference.

### FIELD OF TECHNOLOGY

The present disclosure relates to the field of image communication technology, and more particular to a method and an apparatus for setting a position of a moving cursor in a display page with links.

### BACKGROUND

With quick development of information technology, representation patterns and transmission modes of information have changed: they have changed from traditional formats such as texts (e.g., books and newspapers) and audios (e.g., broadcasts) to a video format having vivid expression and a greater amount of information. Nowadays, TVs and Internet display share, in a video form, comprehensive resources such as various movie and television programs, news, advertisements, chats, educations and games, and therefore, videos have become an irreplaceable way for learning, social networking and entertaining.

To meet people's requirements, various websites have begun to include increasingly strong multimedia functions; especially in a browsing process, a user menu cursor generally works in combination with a mouse to realize selection of files. In conventional ways, when a user obtains multimedia content or browses a page, the moving cursor is disordered and may not be displayed along with the movement of a screen, and therefore, it needs to match with the mouse to control a scroll bar and it often needs to roll the screen multiple times so that the current cursor on the screen can be located on other optional links; in short, operation steps are complex.

In the conventional methods, when a control device is employed on an apparatus to transmit a movement instruction, it is difficult to quickly locate the moving cursor on a position required by the user, and further, a moving speed of the cursor of the menu is even lower; in the case that a plenty of link points or operation options with links are presented on the display page of a webpage, it often requires the user to repeatedly press a button or roll the screen multiple times such that the cursor is moved to a desired page; in short, the mode is single and the operations are complex and inconvenient.

### SUMMARY

To this end, the technical problem that the present disclosure aims to solve is to provide a method, an apparatus and a system for setting a position of a moving cursor in a display page with links to solve the problem that in the conventional ways, a control device on an apparatus cannot achieve quick and accurate locating of the moving cursor.

To solve the above technical problem, the present disclosure discloses a method for setting a position of a moving cursor in a display page with links. The method includes:

Obtain options with the links in the display page prior to output display of the display page with the links is carried out.

Gather options of the same type among the obtained options to form a set.

Set a focus position of a first residence of a moving cursor when the moving cursor moves to the set, keeping the focus position still relative to an interface where the focus position is located, and enable all the options in the set to move to the focus position in sequence according to a movement instruction of a user.

Optionally, wherein positions, in the display page, of the options of the same type are located on same horizontal line.

Optionally, the step of setting the focus position of the first residence of the moving cursor when the moving cursor moves to the set further includes:

When all the options in the set are displayed in a transverse arrangement manner in the display page, set the focus position of the first residence for the options arranged in a row when the moving cursor moves to the row.

Optionally, the focus position of the first residence further is that:

The option in a middle display position among the options arranged in one row in the display page serves as the focus position of the first residence.

Optionally, prior to the moving cursor located on one option receiving an instruction instructing that the moving cursor moves to other options located in the same row with the option, other options arranged in a row or the options of other sets on the display page, the moving cursor on the option is hidden after fixed time expires.

Optionally, the moving cursor is an annular flickering ring formed to surround an outermost frame of the option.

To solve the above technical problem, the present disclosure further discloses an apparatus for setting a position of a moving cursor in a display page with links, including an obtaining unit, a combination unit and a setting unit, wherein,

The obtaining unit is used for obtaining options with the links in the display page prior to output display of the display page with the links is carried out.

The combination unit is used for gathering options of the same type among the obtained options to form a set.

The setting unit is used for setting a focus position of first residence of the moving cursor when the moving cursor moves to the set, keeping the focus position still relative to an interface where the focus position is located, and enable all the options in the set to move to the focus position in sequence according to a movement instruction of a user.

Optionally, wherein the positions, in the display page, of the options of the same type are located on the same horizontal line.

Optionally, the setting unit is further used for, when all the options in the set are displayed in a transverse arrangement manner in the display page, setting the focus position of the first residence for the options arranged in a row when the moving cursor moves to the row.

Optionally, the focus position of the first residence further is that: the option in a middle display position among the options arranged in one row in the display page serves as the focus position of the first residence.

Optionally, prior to the moving cursor located on one option receiving an instruction instructing that the moving cursor moves to other options located in the same row with the option, other options arranged in a row or the options of other sets on the display page, the moving cursor on the option is hidden after fixed time expires.

Optionally, the moving cursor further is an annular flickering ring formed to surround an outermost frame of the option.

Compared with the conventional ways the method and the apparatus for setting the position of the moving cursor in the display page with the links achieve the following effects:
1) As the present disclosure is simple in operation and novel in mode and the cursor can be preset to be fixed, the operations are convenient and fast and lots of time for repeatedly moving the cursor to find out desired results is saved. 2) The present disclosure can realize a slide effect to browse corresponding links while implementing the above-mentioned manner; as a result, the experience of a customer is enhanced so that the user can browse the desired information visually and conveniently.

Certainly, it is not necessary to simultaneously achieve all the above-mentioned technical effects to implement any product of the present disclosure.

### BRIEF DESCRIPTION OF THE DRAWINGS

Accompanying drawings illustrated herein are used for providing further understanding of the present disclosure and form a part of the present disclosure. The schematic embodiments of the present disclosure and descriptions thereof are used for explaining the present disclosure rather than improperly limiting the present disclosure. In the accompanying drawings:

FIG. 1 is a flow block diagram of a method for setting a position of a moving cursor in a display page with links of embodiment 1 of the present disclosure.

FIG. 2 is a flow block diagram of a method for setting a position of a moving cursor in a display page with links of embodiment 2 of the present disclosure.

FIG. 3 is a display diagram of a method for setting a position of a moving cursor in a display page with links of referred embodiment 3 of the present disclosure.

FIG. 4 is a display diagram of a method for setting a position of a moving cursor in a display page with links of referred embodiment 4 of the present disclosure.

FIG. 5 is a structural block diagram for setting a position of a moving cursor in a display page with links of embodiment 4 of the present disclosure.

### DESCRIPTION OF THE EMBODIMENTS

Some words are used for referring to specific components in the description and claims. Those skilled in the art should understand that hardware manufacturers may call the same component by different nouns. The description and claims take the functional differences of the components as a criterion of differentiation instead of differentiating the components based on the difference of names. For instance, ‘containing’ mentioned throughout the description and claims is an open diction and thus should be explained as ‘containing but not limited to’. The word ‘approximately’ refers to being within an acceptable error range, and those skilled in the art can solve the technical problem within a certain error range and substantially achieve the technical effects. Additionally, the word ‘coupling’ contains any direct and indirect electric coupling means herein. Hence, if it is described herein that a first device is coupled to a second device, it represents that the first device can be directly and electrically coupled to the second device or indirectly and electrically coupled to the second device through other devices or coupling means. Preferred embodiments of the present disclosure are described subsequently in the description; however, the descriptions aim at describing a general principle of the present disclosure rather than limiting the scope of the present disclosure. The protection scope of the present disclosure depends on the definitions of appended claims.

### Embodiment 1

As shown in FIG. 1, a method for setting a position of a moving cursor in a display page with links of embodiment 1 of the present disclosure is provided. The method includes:

Step 101, obtain options with the links in the display page prior to output display of the display page with the links is carried out (i.e., generally, before one webpage is opened). Step 102, gather options of the same type among the obtained options to form a set, wherein the positions, in the display page, of the options of the same type are located on the same horizontal line; and

Step 103, set a focus position of first residence of the moving cursor when the moving cursor moves to the set, keeping the focus position still relative to an interface where the focus position is located, and enable all the options in the set to move to the focus position in sequence according to a movement instruction of a user.

Wherein, specifically, the step of setting the focus position of the first residence of the moving cursor when the moving cursor moves to the set in the step 103 is: when all the options in the set are displayed in a transverse arrangement manner in the display page, setting the focus position of the first residence for the options arranged in a row when the moving cursor moves to the row.

In the above step, the focus position of the first residence is that the option in a middle display position among the options arranged in one row in the display page serves as the focus position of the first residence.

Specifically, prior to the moving cursor located on one option receiving an instruction instructing that the moving cursor moves to other options located in the same row with the option, other options arranged in a row or the options of other sets on the display page, the moving cursor on the option is hidden after fixed time expires.

The method of the above embodiment 1 further includes: prior to the moving cursor in the focus position on one option receiving an instruction instructing that the moving cursor moves to the focus positions set for the options of other types on the display page, performing hiding setting on the moving cursor in the focus position on the option.

In the above step, the moving cursor further is an annular flickering ring formed to surround an outermost frame of the option.

### Embodiment 2

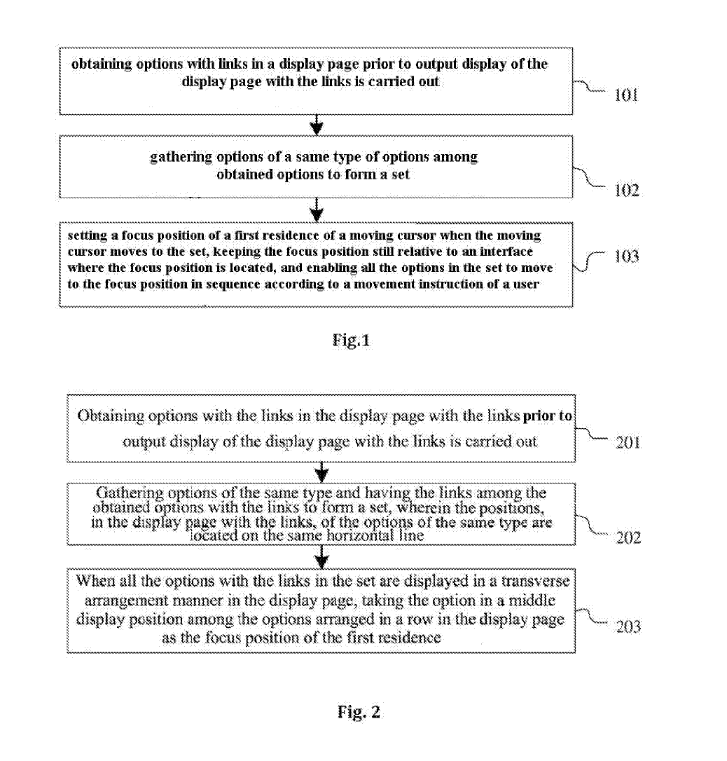

As shown in FIG. 2, a method for setting a position of a moving cursor in a display page with links of embodiment 2 of the present disclosure is provided. The method includes:

Step 201, obtain options with the links in the display page with the links (either picture links or character links, which are not specifically limited herein) prior to output display of the display page with the links is carried out (i.e., generally, before one webpage is opened).

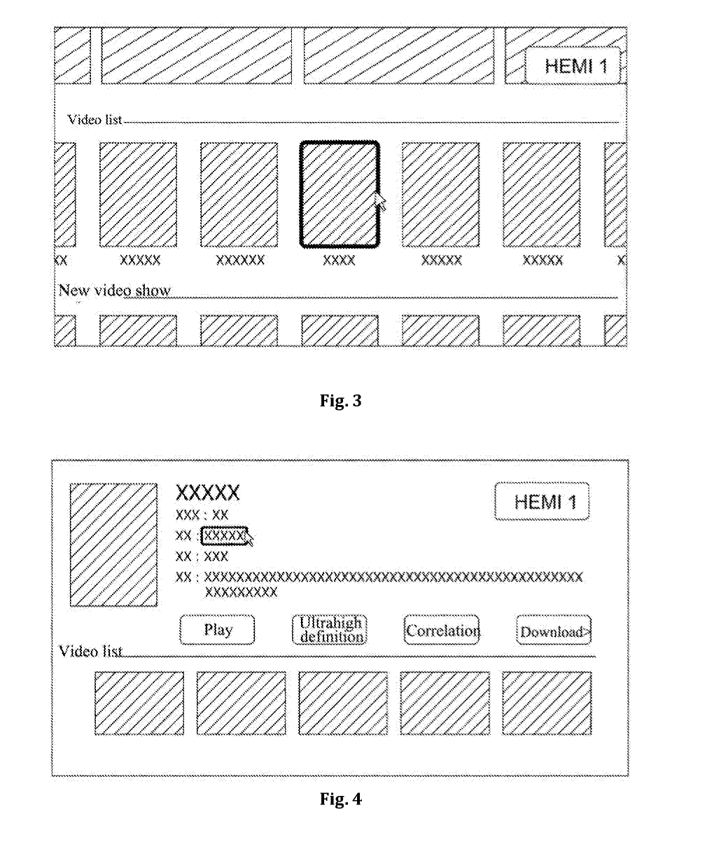

Step 202, gather options of the same type and having the links among the obtained options with the links to form a set, wherein the positions, in the display page with the links, of the options of the same type are located on the same horizontal line (for example, in the step 202 as shown in FIG. 3, the options of 7 video links under a video list in the display page form a set).

Step 203, when all the options containing the links in the set are displayed in a transverse arrangement manner in the display page, take the option in a middle display position among the options arranged in one row in the display page as the focus position of the first residence (as shown in FIG. 3, certainly, although the focus position of the residence set herein is set in the middle position in the present embodiment, a consideration can be made according to a click rate of the user, and therefore, the focus position of the residence is not specifically limited herein).

Wherein, specifically in the step 203, prior to the moving cursor located on one option receiving an instruction instructing that the moving cursor moves to other options located in the same row with the option, other options arranged in a row or the options of other sets on the display page, the moving cursor on the option is hidden after fixed time (the specific time can be set according to the requirements of the user or through apparatus statistics, which is not specifically limited herein) expires (the following major effect is achieved: if no operation is made for a long time, the cursor will be hidden, and when an operation is made, the cursor will appear again).

In the above step, as shown in FIG. 3, the moving cursor further is an annular flickering ring formed to surround an outermost frame of the option (the moving cursor also can be hand-shaped or arrow-shaped, which is not specifically limited herein).

### Embodiment 3

Referring to FIG. 3, the specific disclosure of the method for setting the position of the moving cursor in the display page with the links is described in detail below:

The background is browsing websites (taking video websites as examples) in a terminal (taking a TV terminal as an example in the present embodiment).

The method includes the following specific steps:

Step 1, when a user opens a page, obtain options with picture links or character links in the page.

Step 2, gather options of the same type and having the picture links or the character links among the obtained options with the picture links or the character links to form a set, wherein the positions, in the display page, of the options of the same type are located on the same horizontal line.

Step 3, when all the options having the picture links or the character links in the set are displayed in a transverse arrangement manner in the display page, take the option in a middle display position among the options having the picture links or the character links and arranged in one row in the display page as the focus position of the first residence.

When the user opens the page, the focus position (hereinafter referred to as focus) is displayed in the middle position; when the user performs up and down or left and right movements by using a remote control device (a mouse or touch also can be adopted, which is not specifically limited herein), the focus is always in the middle position, while pictures with the links are changed like slides; prior to the moving cursor located on one option receiving an instruction instructing that the moving cursor moves to other options located in the same row with the option, other options arranged in a row or the options of other sets on the display page, the moving cursor on the option is hidden after fixed time expires; when the user operates again, the moving cursor will be displayed on the picture with the link where it resides last time. The present disclosure is applied to the TV terminal, but also can be applied to mobile terminals (such devices as ipod, iphone, ipad and surface) with touch screens as the same, which is not limited herein.

In the present embodiment, it relates to the disclosure of video websites as long as the webpages thereof contain pictures with links or the characters with links, for example, the method of the present disclosure can be implemented for a shopping webpage, a tourism website, a dating website and the like, which is not specifically limited herein.

### Embodiment 4

Referring to FIG. 4, the specific disclosure of the method for setting the position of the moving cursor in the display page with the links is described in detail below:

The background is browsing specific information in websites (taking video websites as examples) in a terminal (taking a TV terminal as an example in the present embodiment).

The method includes the following steps:

Step 1, when a user opens a page, obtain options with picture links or character links in the page.

Step 2, gather options of the same type and having the picture links or the character links among the obtained options with the picture links or the character links to form a set, wherein the positions, in the display page, of the options of the same type are located on the same horizontal line; and

Step 3, when all the options having the picture links or the character links in the set are displayed in a transverse arrangement manner in the display page, take the option in a left-side display position among the options having the picture links or the character links and arranged in one row in the display page as the focus position of the first residence.

When the user opens the page, the focus position (hereinafter referred to as focus) is displayed in the left-side position; when the user performs up and down movements by using a remote control device (a mouse or touch also can be adopted, which is not specifically limited herein), the focus is always in the left-side position, while pictures with the links are changed like slides; prior to the moving cursor located on one option receiving an instruction instructing that the moving cursor moves to other options located in the same row with the option, other options arranged in a row or the options of other sets on the display page, the moving cursor on the option is hidden after fixed time expires; when the user operates again, the moving cursor will be displayed on the picture with the link where it resides last time.

The present disclosure is applied to the TV terminal, but also can be applied to mobile terminals (such devices as ipod, iphone, ipad and surface) with touch screens as the same, which is not limited herein.

In the present embodiment, it relates to the disclosure of video websites as long as the webpages thereof contain pictures with links or the characters with links, for example, the method of the present disclosure can be implemented for a shopping webpage, a tourism website, a dating website and the like, which is not specifically specified herein.

### Embodiment 5

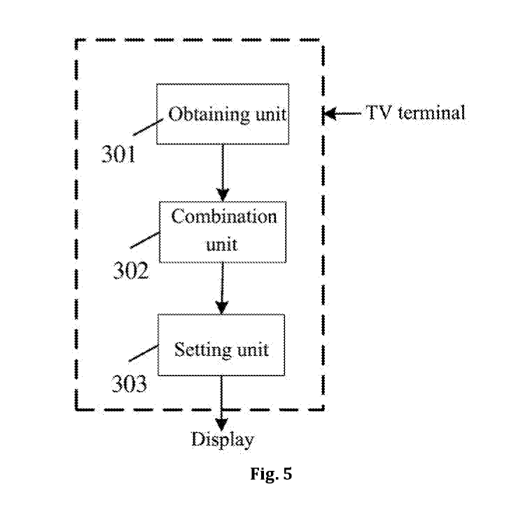

As shown in FIG. 5, an apparatus for setting a position of a moving cursor in a display page with links of embodiment 5 of the present disclosure is provided, coupled with a TV terminal and including: an obtaining unit 301, a combination unit 302 and a setting unit 303, wherein:

The obtaining unit 301 is coupled with the combination unit 302 to obtain options with the links in the display page prior to output display of the display page with the links is carried out.

The combination unit 302 is coupled with the obtaining unit 301 and the setting unit 303, respectively, and used for gathering options of the same type among the obtained options to form a set, wherein the positions, in the display page, of the options of the same type are located on the same horizontal line.

The setting unit 303 is coupled with the combination unit 302 and used for setting a focus position of first residence of the moving cursor when the moving cursor moves to the set, keeping the focus position still relative to an interface where the focus position is located, and enabling all the options in the set to move to the focus position in sequence according to a movement instruction of a user.

Wherein, the setting unit 303 is used for, when all the options in the set are displayed in a transverse arrangement manner in the display page, setting the focus position of the first residence for the options arranged in a row when the moving cursor moves to the row.

Wherein, the focus position of the first residence further is that: the option in a middle display position among the options arranged in one row in the display page serves as the focus position of the first residence.

The setting unit 303 is specifically further used for, prior to the moving cursor located on one option receiving an instruction instructing that the moving cursor moves to other options located in the same row with the option, other options arranged in a row or the options of other sets on the display page, hiding the moving cursor on the option after fixed time expires.

The moving cursor in the above embodiment 5 is an annular flickering ring formed to surround an outermost frame of the option. The moving cursors presented in other specific modes are not specifically limited. It also can be displayed according to the above embodiments herein, which is not specially and redundantly described herein.

The present disclosure further discloses an apparatus for setting a position of a moving cursor in a display page with links, including: one or more processors; a memory; and one or more modules stored in the memory, the one or more modules are configured to perform the following operations when being executed by the one or more processors: Obtain options with links in the display page prior to output display of the display page with the links is carried out. Gather a same type of options among obtained options to form a set. Set a focus position of first residence of the moving cursor when the moving cursor moves to the set, keeping the focus position still relative to an interface where the focus position is located, and enable all the options in the set to move to the focus position in sequence according to a movement instruction of a user.

Optionally, wherein positions, in the display page, of the options of the same type are located on same horizontal line

Optionally, wherein the processor is further configured to perform the following steps, when all the options in the set are displayed in a transverse arrangement manner in the display page, setting the focus position of the first residence for the options arranged in a row when the moving cursor moves to the row.

Optionally, wherein the focus position of the first residence is: the option in a middle display position among the options arranged in one row in the display page.

Optionally, wherein further, the moving cursor on the option is hidden after a fixed time period expires, prior to the moving cursor located on one option receiving an instruction instructing that the moving cursor moves to other options located in the same row with the option, other options arranged in a row or the options of other sets on the display page.

Optionally, wherein the moving cursor is an annular flickering ring formed to surround an outermost frame of the option.

As the embodiments of the present disclosure have been described in detail in the method part, the expanded descriptions of a part, corresponding to the method, of the apparatus involved in the embodiment are omitted and not redundantly described herein. Descriptions of specific content in the apparatus can refer to the content of the method embodiments, which are not specifically limited herein.

Compared with the conventional ways, the method and the apparatus for setting the position of the moving cursor in the display page with the links achieve the following effects:

1) As the present disclosure is simple in operation and novel in mode and the cursor can be preset to be fixed, the operations are convenient and fast and lots of time of repeatedly moving the cursor to find out desired results is saved. 2) The present disclosure can realize a slide effect to browse corresponding links while implementing the above-mentioned manner; as a result, the experience of a customer is enhanced so that the user can browse the desired information visually and conveniently.

It further needs to be noted that the terms ‘including’ and ‘containing’ or any other variants are intended to cover exclusive containing, such that a process, a method, a commodity or an apparatus including a series of elements includes not only those elements, but also other elements not explicitly listed, or further includes inherent elements of the process, the method, the commodity or the apparatus. Without more limitations, elements defined by the statement ‘including a ’ shall not be exclusive of additional same elements further existing in the process, the method, the commodity or the apparatus.

Those skilled in the art should understand that the embodiments of the present disclosure can be provided as methods, apparatuses or computer program products. Hence, the present disclosure can be implemented in the forms of complete hardware embodiments, complete software embodiments or software and hardware combined embodiments. Additionally, the present disclosure can be in the form of the computer program product implemented on one or more computer-available storage mediums (including but not limited to magnetic disk memories, CD-ROMs, optical memories and the like) containing computer-available program codes therein.

The foregoing descriptions are merely embodiments of the present disclosure rather than limiting the present disclosure. For those skilled in the art, various alterations and variations can be made to the present disclosure. Any modifications, equivalent substitutions, improvements and the like made within the spirit and the principle of the present disclosure all should fall into the claim scope of the present disclosure.

1. A method for setting a position of a moving cursor in a display page with links, comprising:
obtaining options with links in a display page prior to output display of the display page with the links is carried out;
gathering options of a same type of options among obtained options to form a set; and
setting a focus position of a first residence of a moving cursor when the moving cursor moves to the set, keeping the focus position still relative to an interface where the focus position is located, and enabling all the options in the set to move to the focus position in sequence according to a movement instruction of a user.

2. The method for setting the position of the moving cursor in the display page with the links of claim 1, wherein setting the focus position of the first residence of the moving cursor when the moving cursor moves to the set further comprises
setting ,when all the options in the set are displayed in a transverse arrangement manner in the display page, the focus position of the first residence for the options arranged in a row when the moving cursor moves to the row.

3. The method for setting the position of the moving cursor in the display page with the links of claim 2, wherein the focus position of the first residence is
the option in a middle display position among the options arranged in one row in the display page.

4. The method for setting the position of the moving cursor in the display page with the links of claim 3, further comprising:
hiding the moving cursor on the option after a fixed time period expires, prior to the moving cursor located on one option receiving an instruction instructing that the moving cursor moves to other options located in the same row with the option, other options arranged in a row or the options of other sets on the display page.

5. The method for setting the position of the moving cursor in the display page with the links of claim 4, wherein the moving cursor is an annular flickering ring formed to surround an outermost frame of the option.

6. An apparatus for setting a position of a moving cursor in a display page with links, comprising:
an obtaining unit configured for obtaining options with links in a display page prior to output display of the display page with the links is carried out;
a combination unit configured for gathering a same type of options among obtained options to form a set; and
a setting unit configured for setting a focus position of a first residence of a moving cursor when the moving cursor moves to the set, keeping the focus position still relative to an interface where the focus position is located, and enabling all the options in the set to move to the focus position in sequence according to a movement instruction of a user.

7. The apparatus for setting the position of the moving cursor in the display page with the links of claim 6, wherein the setting unit is further used for, when all the options in the set are displayed in a transverse arrangement manner in the display page, setting the focus position of the first residence for the options arranged in a row when the moving cursor moves to the row.

8. The apparatus for setting the position of the moving cursor in the display page with the links of claim 7, wherein the focus position of the first residence is: the option in a middle display position among the options arranged in one row in the display page.

9. The apparatus for setting the position of the moving cursor in the display page with the links of claim 8, wherein further, the moving cursor on the option is hidden after a fixed time period expires, prior to the moving cursor located on one option receiving an instruction instructing that the moving cursor moves to other options located in the same row with the option, other options arranged in a row or the options of other sets on the display page.

10. The apparatus for setting the position of the moving cursor in the display page with the links of claim 9, wherein the moving cursor is an annular flickering ring formed to surround an outermost frame of the option.

11. The method for setting the position of the moving cursor in the display page with the links of claim 1, wherein positions, in the display page, of the options of the same type are located on same horizontal line.

12. The apparatus for setting the position of the moving cursor in the display page with the links of claim 6, wherein positions, in the display page, of the options of the same type are located on same horizontal line

13. An system for setting a position of a moving cursor in a display page with links, comprising:
one or more processors;
a memory; and
one or more modules stored in the memory, the one or more modules are configured to perform the following operations when being executed by the one or more processors:
obtaining options with links in the display page prior to output display of the display page with the links is carried out;
gathering a same type of options among obtained options to form a set; and
setting a focus position of first residence of the moving cursor when the moving cursor moves to the set, keeping the focus position still relative to an interface where the focus position is located, and enabling all the options in the set to move to the focus position in sequence according to a movement instruction of a user.

14. The system for setting the position of the moving cursor in the display page with the links of claim 13, wherein positions, in the display page, of the options of the same type are located on same horizontal line.

15. The system for setting the position of the moving cursor in the display page with the links of claim 13, wherein the processor is further configured to perform the following steps, when all the options in the set are displayed in a transverse arrangement manner in the display page, setting the focus position of the first residence for the options arranged in a row when the moving cursor moves to the row.

16. The system for setting the position of the moving cursor in the display page with the links of claim 15, wherein the focus position of the first residence is: the option in a middle display position among the options arranged in one row in the display page.

17. The system for setting the position of the moving cursor in the display page with the links of claim 16, wherein further, the moving cursor on the option is hidden after a fixed time period expires, prior to the moving cursor located on one option receiving an instruction instructing that the moving cursor moves to other options located in the same row with the option, other options arranged in a row or the options of other sets on the display page.

18. The system for setting the position of the moving cursor in the display page with the links of claim 17, wherein the moving cursor is an annular flickering ring formed to surround an outermost frame of the option.
